(19) United States
(12) Patent Application Publication
(10) Pub. No.: US 2023/0167288 A1
(43) Pub. Date: Jun. 1, 2023

(54) THERMOPLASTIC ELASTOMER MHP COMPOSITE AND PREPARATION METHOD THEREOF

(71) Applicants: Yunlong SHI, Shanghai (CN); Qionghua CAI, Shanghai (CN)

(72) Inventors: Yunlong SHI, Shanghai (CN); Qionghua CAI, Shanghai (CN)

(73) Assignees: Yunlong SHI, Shanghai (CN); Qionghua CAI, Shanghai (CN)

(21) Appl. No.: 17/537,526

(22) Filed: Nov. 30, 2021

(51) Int. Cl. C08L 23/14; C08L 23/12; C08L 23/16; C08L 53/02

(52) U.S. Cl. CPC C08L 23/14; C08L 23/12; C08L 23/16; C08L 53/02; C08L 2205/035

(57) ABSTRACT

The thermoplastic elastomer MHP composite is composed of the following components in percent by weight: 1-30% of polypropylene, 1-30% of a styrenic block copolymer, 10-40% of a rubber processing oil, 10-30% of a propylene-based elastomer, 10-55% of an inorganic filler, 0.5-10% of a compatibilizer, 1-12% of a petroleum resin, and 0.4-6.5% of a processing aid. The thermoplastic elastomer MHP composite prepared by the present disclosure is odorless with good mechanical properties and aging resistance, and has an excellent anti-slip effect particularly used in the dry and wet dual-use household mats.

### TECHNICAL FIELD

The present disclosure relates to the technical field of polymeric elastomers, and specifically relates to a thermoplastic elastomer modified hot-melted polymer (MHP) composite and a preparation method thereof.

### BACKGROUND

Thermoplastic elastomers are usually materials with low elastic modulus, which have the ability to repeatedly stretch to more than 2 times their initial length at room temperature, and return to their original shape due to stress relief. The thermoplastic elastomers not only have high elasticity, aging resistance, and oil resistance of the traditional vulcanized rubber, but also have convenient and widely-used processing methods of the ordinary plastic materials, combining the advantages of the rubbery materials and the plastic materials. However, the existing thermoplastic elastomers have poor anti-slip performance on the wet and slippery floor when used as the base materials of the wet and dry dual-use mats, leading to serious safety problem.

### SUMMARY

To solve the shortcomings in the prior art, the present disclosure provides a thermoplastic elastomer MHP composite and a preparation method thereof.

To achieve the above-mentioned objects, the present disclosure employs the following technical solutions:

The thermoplastic elastomer MHP composite is composed of the following components in percent by weight: 1-30% of polypropylene, 1-30% of a styrenic block copolymer, 10-40% of a rubber processing oil, 10-30% of a propylene-based elastomer, 10-55% of an inorganic filler, 0.5-10% of a compatibilizer 0.5-10%, 1-12% of a petroleum resin 1-12%, and 0.4-6.5% of a processing aid.

Polypropylene is one of copolymerized polypropylene and homopolymerized polypropylene.

The styrenic block copolymer is one of a linear SEBS block copolymer and a star SEBS block copolymer, and a content of styrene in the styrenic block copolymer is 30-33 wt %.

The rubber processing oil is naphthenic oil.

The propylene-based elastomer is an ethylene-propylene copolymer.

The inorganic filler is one of calcium carbonate and talc.

The compatibilizer is one of aluminate ester and maleic anhydride-grafted polypropylene, to improve the affinity of the inorganic filler with polypropylene and the dispersibility of the inorganic filler.

The petroleum resin is a hydrogenated petroleum resin.

The processing aid is composed of an antioxidant, a lubricant and a colorant.

The processing aid is composed of 0.3-1 wt % of the antioxidant, 0.1-5 wt % of the lubricant and 0-0.5 wt % of the colorant.

The antioxidant is an antioxidant compounded of hindered phenols with phosphites.

The lubricant is one of zinc stearate and calcium stearate.

A method for preparing the MHP composite as the thermoplastic elastomer comprises the following steps:

step 1: weighing the components in percent by weight; and

step 2: mixing the weighed components fully and then feeding into a screw extruder for granulation.

In step 2 a rotation speed of the screw extruder is 100-500 r/min, and the granulation is carried out at 160-210° C.

The thermoplastic elastomer MHP composite prepared by the present disclosure is odorless with good mechanical properties and aging resistance, and has an excellent anti-slip effect particularly used in the dry and wet dual-use household mats.

### DETAILED DESCRIPTION OF THE EMBODIMENTS

The technical solutions of the present disclosure will be described clearly and completely with reference to the examples below. Obviously, the described examples are only part of the examples of the present disclosure, not all of them.

### EXAMPLE 1

The antioxidant 1010 and the antioxidant 168 are weighed to mix at the ratio of 1:1, to obtain the antioxidant.

The components are weighed according to the following percent by weight: 10% of polypropylene, 3% of SEBS, 20% of the ethylene-propylene copolymer, 24.5% of naphthenic oil, 38% of calcium carbonate, 1% of zinc stearate, 0.5% of aluminate ester, 2% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### EXAMPLE 2

The antioxidant 1076 and the antioxidant 168 are weighed to mix at the ratio of 1:1, to obtain the antioxidant.

The components are weighed according to the following percent by weight: 15% of polypropylene, 5% of SEBS, 15% of the ethylene-propylene copolymer, 17.5% of naphthenic oil, 42.5% of calcium carbonate, 1% of zinc stearate, 0.5% of aluminate ester, 2.5% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### EXAMPLE 3

The antioxidant 1076 and the antioxidant 168 are weighed to mix at the ratio of 1:1, to obtain the antioxidant.

The components are weighed according to the following percent by weight: 8% of polypropylene, 10% of SEBS, 10% of the ethylene-propylene copolymer, 29.5% of naphthenic oil, 37% of calcium carbonate, 1% of zinc stearate, 0.5% of aluminate ester, 3% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### EXAMPLE 4

The antioxidant 1010 and the antioxidant 168 are weighed to mix at the ratio of 1:1, to obtain the antioxidant.

The components are weighed according to the following percent by weight: 1% of polypropylene, 30% of SEBS, 20% of the ethylene-propylene copolymer, 22.5% of naphthenic oil, 10% of talc, 5% of calcium stearate, 10% of aluminate ester, 0.2% of the colorant, 1% of the hydrogenated petroleum resin, and 0.3% of the antioxidant.

The weighed components are added to the high-speed mixer to mix for 12 min, and then extruded by the screw extruder with at 165° C. and 450 r/min for granulation, to obtain the high-performance and odorless thermoplastic elastomer MHP composite.

### EXAMPLE 5

The antioxidant 1076 and the antioxidant 168 are weighed to mix at the ratio of 1:1, to obtain the antioxidant.

The components are weighed according to the following percent by weight: 30% of polypropylene, 1% of SEBS, 30% of the ethylene-propylene copolymer, 10% of naphthenic oil, 11% of calcium carbonate, 0.1% of zinc stearate, 5% of maleic anhydride-grafted polypropylene, 0.4% of the colorant, 12% of the hydrogenated petroleum resin, and 0.5% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### EXAMPLE 6

The antioxidant 1010 and the antioxidant 168 are weighed to mix at the ratio of 1:1, to obtain the antioxidant.

The components are weighed according to the following percent by weight: 5% of polypropylene, 5% of SEBS, 14.5% of the ethylene-propylene copolymer, 40% of naphthenic oil, 24% of talc, 2% of zinc stearate, 3% of aluminate ester, 0.5% of the colorant, 5% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

Further, Comparative examples 1-4 are provided by the present disclosure.

### Comparative Example 1

The antioxidant 1076 and the antioxidant 168 are weighed to mix at the ratio of 1:1, to obtain the antioxidant.

The components are weighed according to the following percent by weight: 11% of polypropylene, 10% of SEBS, 10% of the ethylene-propylene copolymer, 29.5% of naphthenic oil, 37% of calcium carbonate, 1% of zinc stearate, 0.5% of aluminate ester, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### Comparative Example 2

The antioxidant 1076 and the antioxidant 168 are weighed to mix at the ratio of 1:1, to obtain the antioxidant.

The components are weighed according to the following percent by weight: 8% of polypropylene, 10% of SEBS, 10% of the ethylene-propylene copolymer, 29.5% of naphthenic oil, 37% of calcium carbonate, 1% of zinc stearate, 0.5% of aluminate ester, 3% of the terpene resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### Comparative Example 3

The antioxidant 1076 and the antioxidant 168 are weighed to mix at the ratio of 1:1, to obtain the antioxidant.

The components are weighed according to the following percent by weight: 13% of polypropylene, 15% of SEBS, 29.5% of naphthenic oil, 37% of calcium carbonate, 1% of zinc stearate, 0.5% of aluminate ester, 3% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

### Comparative Example 4

The antioxidant 1076 and the antioxidant 168 are weighed to mix at the ratio of 1:1, to obtain the antioxidant.

The components are weighed according to the following percent by weight: 8% of polypropylene, 10% of SEBS, 10% of EPDM, 29.5% of naphthenic oil, 37% of calcium carbonate, 1% of zinc stearate, 0.5% of aluminate ester, 3% of the hydrogenated petroleum resin, and 1% of the antioxidant.

The weighed components are added to the high-speed mixer to mix for 12 min, and then extruded by the screw extruder at 165° C. and 450 r/min for granulation, to obtain the high-performance and odorless thermoplastic elastomer MHP composite.

The thermoplastic elastomer MHP composites obtained in Examples 1-6 and Comparative examples 1-4 are processed into the bath mat to test the mechanical properties for comparison. The mechanical properties are tested by ASTM, the melt flow index is determined at 190° C. with the standard weight of 2.16 kg, and the odor is tested by olfactometry. The test results are shown in Table 1.

TABLE 1

| | | Tensile | Elongation | Melt flow | | |
|---|---|---|---|---|---|---|
| | | strength | at break | index | | Other |
| | | (MPa) | (%) | (g/10 min) | Odor | performance |
| Examples | 1 | 3.5 | ≥500 | 40 | odorless | simple |
| | | | | | | processing |
| | | | | | | and low cost |
| | 2 | 4 | ≥500 | 30 | odorless | simple |
| | | | | | | processing |
| | | | | | | and low cost |
| | 3 | 2.8 | ≥500 | 35 | odorless | simple |
| | | | | | | processing |
| | | | | | | and low cost |
| | 4 | 3.0 | ≥500 | 20 | odorless | simple |
| | | | | | | processing |
| | | | | | | and low cost |
| | 5 | 5 | ≥550 | 32 | odorless | simple |
| | | | | | | processing |
| | | | | | | and low cost |
| | 6 | 2.9 | ≥500 | 45 | odorless | simple |
| | | | | | | processing |
| | | | | | | and low cost |
| Comparative | 1 | 2.7 | ≥400 | 34 | odorless | simple |
| examples | | | | | | processing |
| | | | | | | and low cost |
| | 2 | 2.5 | ≥400 | 35 | odorous | simple |
| | | | | | | processing |
| | | | | | | and low cost |
| | 3 | 2.4 | ≥400 | 37 | odorless | simple |
| | | | | | | processing |
| | | | | | | and low cost |
| | 4 | 2.1 | ≥400 | 27 | odorless | simple |
| | | | | | | processing |
| | | | | | | and low cost |

It can be seen from Table 1 that the tensile strength and elongation at break of the thermoplastic elastomer MHP composites prepared in Examples 1-6 are better than those of the thermoplastic elastomer MHP composites prepared in Comparative examples 1-4.

The thermoplastic elastomer MHP composites prepared in Examples 1-6 and Comparative examples 1-4 are processed into the bath mat to test the anti-slip performance, and the test results are shown in Table 2.

| | Examples | | | | | | Comparative examples | | | |
|---|---|---|---|---|---|---|---|---|---|---|
| Test items | 1 | 2 | 3 | 4 | 5 | 6 | 1 | 2 | 3 | 4 |
| Anti-slip | 0.91 | 0.90 | 0.94 | 0.96 | 0.95 | 0.88 | 0.81 | 0.76 | 0.73 | 0.79 |
| performance | | | | | | | | | | |
| in the dry | | | | | | | | | | |
| state (COF) | | | | | | | | | | |
| Anti-slip | 0.67 | 0.70 | 0.69 | 0.62 | 0.71 | 0.68 | 0.20 | 0.22 | 0.24 | 0.28 |
| performance | | | | | | | | | | |
| in the wet | | | | | | | | | | |
| state (COF) | | | | | | | | | | |

In summary, it can be seen from Table 2 that after the thermoplastic elastomer MHP composites prepared in Examples 1-6 are processed into the bath mat, the anti-slip performance in both dry and wet states are better than those of the thermoplastic elastomer MHP composites prepared in Comparative examples 1-4. Therefore, it can be seen from Table 2 of the present disclosure that adding the propylene-based elastomer and the petroleum resin as the raw materials to thermoplastic elastomer MHP composite improves the anti-slip performance and mechanical properties of the thermoplastic elastomer MHP composite in the wet and slippery state.

In summary, the thermoplastic elastomer MHP composite and the preparation method thereof are provided in the examples of the present disclosure. The thermoplastic elastomer MHP composite prepared by the present disclosure is odorless with good mechanical properties and aging resistance, and has excellent anti-slip effect particularly used in the wet and dry dual-use household mats.

The above examples are only the preferred examples of the present disclosure, not intended to limit the protection scope of the present disclosure. Within the technical scope of the present disclosure, the equivalent replacements and modifications made by those skilled in the art according to the technical solutions and inventive concept of the present disclosure shall fall within the protection scope of the present disclosure.

What is claimed is:

1. A thermoplastic elastomer MHP composite, comprising the following components in percent by weight: 1-30% of polypropylene, 1-30% of a styrenic block copolymer, 10-40% of a rubber processing oil, 10-30% of a propylene-based elastomer, 10-55% of an inorganic filler, 0.5-10% of a compatibilizer, 1-12% of a petroleum resin, and 0.4-6.5% of a processing aid.

2. The thermoplastic elastomer MHP composite according to claim 1, wherein, the polypropylene is a copolymerized polypropylene or a homopolymerized polypropylene.

3. The thermoplastic elastomer MHP composite according to claim 1, wherein, the styrenic block copolymer is a linear SEBS block copolymer or a star SEBS block copolymer, and a content of styrene in the styrenic block copolymer is 30-33 wt %.

4. The thermoplastic elastomer MHP composite according to claim 1, wherein,
the rubber processing oil is a naphthenic oil;
the propylene-based elastomer is an ethylene-propylene copolymer; and
the inorganic filler is calcium carbonate or talc.

5. The thermoplastic elastomer MHP composite according to claim 1, wherein,
the compatibilizer is an aluminate ester or a maleic anhydride-grafted polypropylene, the compatibilizer improves an affinity of the inorganic filler with the polypropylene and a dispersibility of the inorganic filler; and
the petroleum resin is a hydrogenated petroleum resin.

6. The thermoplastic elastomer MHP composite according to claim 1, wherein, the processing aid comprises an antioxidant, a lubricant and a colorant.

7. The thermoplastic elastomer MHP composite according to claim 1, wherein, the processing aid comprises 0.3-1 wt % of an antioxidant, 0.1-5 wt % of a lubricant, and 0-0.5 wt % a colorant.

8. The thermoplastic elastomer MHP composite according to claim 7, wherein,
the antioxidant is an antioxidant compounded of hindered phenols with phosphites; and
the lubricant is zinc stearate or calcium stearate.

9. A method for preparing the thermoplastic elastomer MHP composite according to claim 1, comprising the following steps:
step 1: weighing the components in percent by weight; and
step 2: mixing the components weighed in step 1 fully to obtain a mixture and then feeding the mixture into a screw extruder for a granulation.

10. The method for preparing the thermoplastic elastomer MHP composite according to claim 9, wherein, a rotation speed of the screw extruder is 100-500 r/min, and the granulation is carried out at 160-210° C.

11. The method for preparing the thermoplastic elastomer MHP composite according to claim 9, wherein, the polypropylene is a copolymerized polypropylene or a homopolymerized polypropylene.

12. The method for preparing the thermoplastic elastomer MHP composite according to claim 9, wherein, the styrenic block copolymer is a linear SEBS block copolymer or a star SEBS block copolymer, and a content of styrene in the styrenic block copolymer is 30-33 wt %.

13. The method for preparing the thermoplastic elastomer MHP composite according to claim 9, wherein,
the rubber processing oil is naphthenic oil;
the propylene-based elastomer is an ethylene-propylene copolymer; and
the inorganic filler is calcium carbonate or talc.

14. The method for preparing the thermoplastic elastomer MHP composite according to claim 9, wherein,
the compatibilizer is an aluminate ester or a maleic anhydride-grafted polypropylene, the compatibilizer improves an affinity of the inorganic filler with the polypropylene and a dispersibility of the inorganic filler; and
the petroleum resin is a hydrogenated petroleum resin.

15. The method for preparing the thermoplastic elastomer MHP composite according to claim 9, wherein, the processing aid comprises an antioxidant, a lubricant and a colorant.

16. The method for preparing the thermoplastic elastomer MHP composite according to claim 9, wherein, the processing aid comprises 0.3-1 wt % of an antioxidant, 0.1-5 wt % of a lubricant, and 0-0.5 wt % a colorant.

17. The method for preparing the thermoplastic elastomer MHP composite according to claim 16, wherein,
the antioxidant is an antioxidant compounded of hindered phenols with phosphites; and
the lubricant is zinc stearate or calcium stearate.
